(19) United States
(12) Patent Application Publication
(10) Pub. No.: US 2008/0245727 A1
(43) Pub. Date: Oct. 9, 2008

(54) Filter insert and method for the production of the filter insert

(75) Inventor: Georg Muller, Minden (DE)

Correspondence Address: VENABLE LLP, P.O. BOX 34385, WASHINGTON, DC, 20043-9998, US

(73) Assignee: Melitta Haushaltsprodukte GmbH & Co. KG, Minden (DE)

(21) Appl. No.: 11/783,390

(22) Filed: Apr. 9, 2007

(30) Foreign Application Priority Data
Apr. 7, 2007 (DE) 10 2006 016 415.6

(51) Int. Cl. A47J 31/08; B01D 39/00; B29C 65/78; B32B 38/06

(52) U.S. Cl. 210/506; 156/250

(57) ABSTRACT

A filter insert for brewing coffee includes a cone-shaped filter body comprising a bottom, side walls, and an opening for filling in extraction material. At least one strip with at least one of markings or aromatic substances is arranged inside the filter body.

### CROSS-REFERENCE TO RELATED APPLICATION

This application claims the priority of German Patent Application No: 10 2006 016 415.6, filed on Apr. 7, 2006, the subject matter of which is incorporated herein by reference together with each U.S. and foreign patent and patent application mentioned below.

### BACKGROUND OF THE INVENTION

The present invention relates to a filter insert, used in particular for brewing coffee, consisting of a cone-shaped filter body with a bottom, side walls and an opening for filling in an extraction material. The invention also relates to a method for producing cone-shaped filter inserts.

Cone-shaped filter paper inserts for brewing coffee are known, which can be filled with coffee grounds. These inserts are closed along the bottom and one side edge with embossed seams, designed to securely join the filter paper along the edges. The filter paper can furthermore be provided with imprinted areas, for example for the purpose of advertisement, wherein these imprinted areas in most cases are hard to see.

Attempts have also been made to produce aromatized filter inserts. However, it has proven difficult to produce these filter inserts with the wet-application method.

European Patent document EP 1172054 discloses a method for producing filter paper inserts, wherein these filter paper inserts are cut out of a filter material web and a double embossed seam is generated along a bottom and one side wall of the filter paper insert. These known filter paper inserts have no functionalities other than the filtering characteristic.

### SUMMARY OF THE INVENTION

It is an object of the present invention to provide a filter insert and a method for producing a cone-shaped filter insert, which provide the filter insert with an additional functionality.

The above and other objects are accomplished according to the invention by the provision of filter insert, in particular for brewing coffee, which in one embodiment comprises: a cone-shaped filter body comprising a bottom, side walls, and an opening for filling in extraction material; and at least one strip with at least one of markings or aromatic substances arranged inside the filter body.

The filter insert can thus provide additional functions besides the filtering function. For example, the strip inside the filter body can provide the user with information relating to the filling level of the filter insert, or it can be used to provide aromatic substances that give the filtered fluid, preferably brewed coffee, a very specific taste note.

To simplify the production of the filter insert, the strip is preferably attached to one embossed seam of the filter body, wherein farther away from the embossed seam the strip can be arranged loosely inside the filter body. This type of arrangement makes it easy to remove the strip from the filter body if the user does not wish to utilize the desired function in special cases, for example if the strip is aromatized and this is not desired. The loose arrangement inside the filter body furthermore makes the strip easy to see because it differs from the material for the filter insert.

According to one embodiment of the invention, the strip is provided with a marking for indicating the filling level. The markings can also take the form of concrete quantities for volume or weight, wherein the markings may give the user an indication of how many cups of coffee can be brewed with a corresponding filling level for the coffee grounds.

According to a different embodiment of the invention, the strip is provided with an aromatic substance, wherein the aromatic substance can be covered with a protective coating which dissolves when it comes in contact with a fluid, preferably hot water. In that case, the aromatic substance can retain its aroma over a long period of time because it is arranged under a protective coating and is released to the surrounding fluid only during a brewing operation.

The strip may be embodied with a different color than the filter material, so that it can be seen easily. As a result, the strip is recognized immediately by the user and can also be seen from the outside and through the material, particularly if filter paper is used for the filter material.

According to another aspect of the invention there is provides a method for producing a cone-shaped filter insert, which in one embodiment includes: conveying a filter material web; placing at least one strip onto the filter material web being conveyed; folding the filter material web so that the at least one strip is arranged inside the folded filter material web; and cutting and embossing the folded filter material web for producing a filter insert.

The production method consequently does not require any significant additional expenditure, wherein the strip provides an additional functionality for the filter insert, as described in the above with reference to the filter insert.

With the above method, the filter material web may be embossed so that the at least one strip is affixed to one embossed seam of the filter insert. The strip may extend parallel to a folding edge of the filter material web to permit a conveying of the filter material web and the strip in the same direction and to make it possible to achieve high operating speeds.

### BRIEF DESCRIPTION OF THE DRAWINGS

These and other features and advantages of the invention will be further understood from the following detailed description with reference to the accompanying drawings, which show in:

FIG. 1A schematic view illustrating a method for producing cone-shaped filter inserts, and

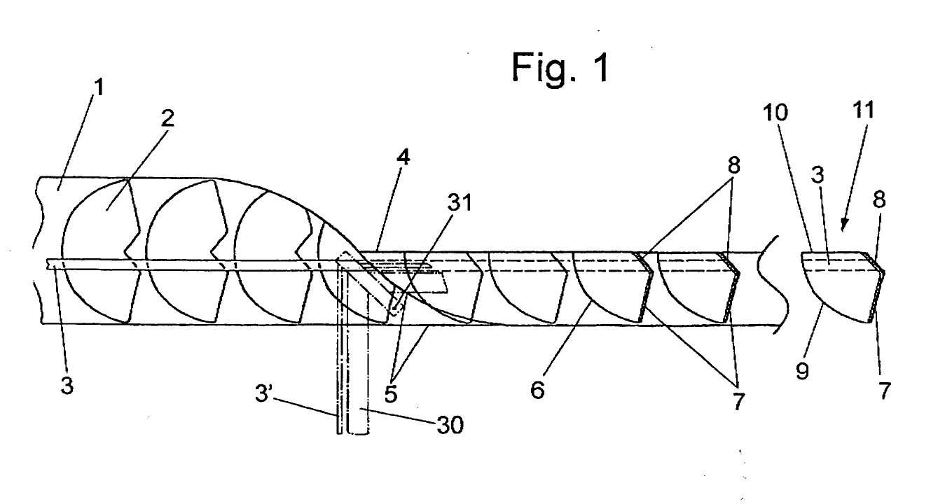

FIG. 2A view of a filter insert according to the invention.

### DETAILED DESCRIPTION

A filter material web 1, preferably consisting of filter paper or a non-woven material, is conveyed in one direction. The width of the filter material web approximately matches the width of one blank 2 from which a filter insert is subsequently produced. However, the filter material web 1 can also be embodied wider, so that two blanks 2 can be arranged side-by-side. A strip 3 is placed onto the web, off-center and parallel to the filter material web 1. The blanks 2 are only drawn onto the filter material web 1 for an easier explanation of the production method. However, it is also possible to provide at least a portion of the cutting outline for the blank 2, particularly if the filter insert is to be provided with an aid for opening it.

In a subsequent step, the filter material web 1 is folded, such that a folding edge 4 forms in the center of the web and the free edges 5 of the filter material web 1 are placed one on top of the other. As a result, the strip 3 is positioned on the inside of the folded filter material web.

One or more strips 3′ and 30 can furthermore be inserted from the side into the filter material web with the aid of a deflection roller 31. This roller is arranged upstream of the folding location for the material web 1, at an angle of approximately 45° relative to the movement direction of the filter material web 1, so as to supply the one strip and/or several strips 3′ and/or 30 either from the side or from the top. The strips 3′ and 30 can have different widths and functions.

The filter material web, folded in this way, is subsequently embossed and then cut, wherein an embossed seam 7 is provided along the side edge and an embossed seam 8 along the bottom for joining the filter material and wherein a cut edge 6 is provided opposite the bottom. The area adjacent to the embossed seams 7 and 8 is also cut, so that a finished filter insert 11 is produced, with an opening 9 for filling in a material to be filtered. In the process, a filter body is produced with an embossed seam 7 on the side, an embossed seam 8 on the bottom, as well as a folded edge 10 on the other side. A strip 3 is arranged inside the filter body at a distance to the folding edge 10, which increases the functionality of the filter insert 11.

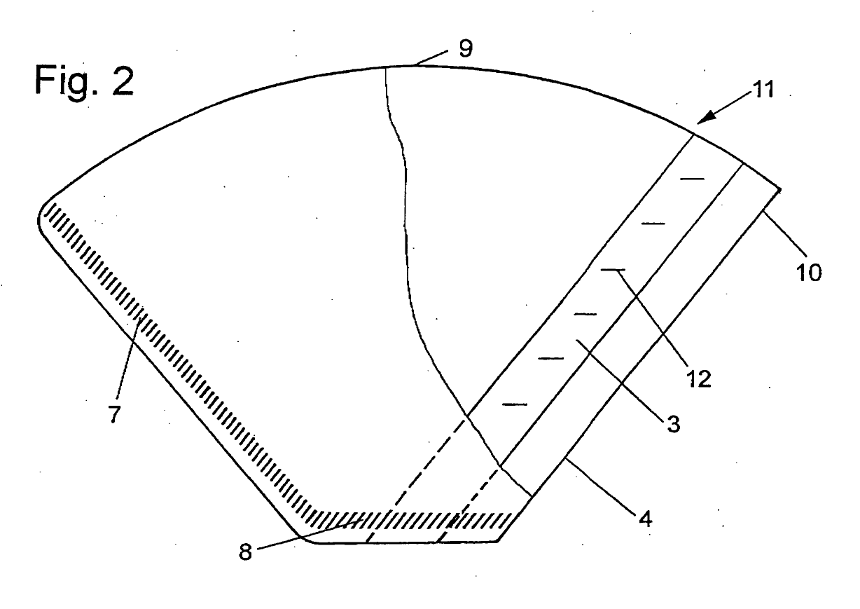

According to FIG. 2, the strip 3 is provided with markings 12, which can provide the user with information concerning the filling level inside the filter body. The markings can furthermore be used to indicate to the user the amount of coffee grounds needed to brew a specific number of cups of coffee. The strip 3 can be incorporated into the filter body so that it is easily visible and, in particular, can have a color that differs from the surrounding filter material. For example, if the filter material used is a white filter paper, then the strip 3 can consist of brown filter paper. The strip 3 is thus immediately visible when the user opens the filter body and it is also visible from the outside through the white paper. The strip 3 can consist of the same material as the filter or of a different material. The strip 3 can furthermore be imprinted and/or embossed for applying the markings 12.

The strip 3 is attached to the embossed seam 8 at the bottom of the filter insert 11 and is otherwise positioned loosely between the two layers of filter material. However, the strip 3 can additionally also be glued to the filter material.

According to one embodiment, the strip 3 can be provided with one or several aromatic substances that are furthermore coated with a protective coating, so that the aromatic substances remain fresh for a long time. The protective layer can consist of a water-soluble material, so that the protective layer dissolves during the brewing of coffee and the aromatic substances can be released. If the strip 3 is attached only to the embossed seam 7 and/or 8, it can also be removed completely or partially if necessary, for example for metering out the aromatic substances.

For the exemplary embodiment shown, a strip 3 is affixed along the embossed seam on the bottom and is positioned inside the filter body. A wider strip can additionally be attached to an embossed seam 7 on the side, wherein this strip can also be provided with markings, aromatic substances, and the like, as described in the above.

It is furthermore possible, of course, to provide one or several strips 3 and/or 30 in the filter body, wherein these can be attached at different locations to the embossed seam 7 and/or 8.

Instead of attaching the strip 3 to the embossed seam 8 on the bottom, the strip 3 can also be attached more toward the side and on the embossed seam 7, meaning the strip 3 can also have a shorter shape.

It will be understood that the above description of the present invention is susceptible to various modifications, changes and adaptations, and the same are intended to be comprehended within the meaning and range of equivalents of the appended claims.

What is claimed is:

1. A filter insert for brewing coffee, comprising:
a cone-shaped filter body comprising a bottom, side walls, and an opening for filling in extraction material; and
at least one strip with at least one of markings or aromatic substances arranged inside the filter body.

2. The filter insert according to claim 1, wherein the filter body has at least one embossed seam and the strip is attached to at least one of the embossed seams.

3. The filter insert according to claim 1, wherein the filter body has at least one embossed seam and the strip is arranged loosely inside the filter body at a distance to the at least one embossed seam.

4. The filter insert according to claim 1, further including markings arranged on the strip for detecting a filling level of the filter.

5. The filter insert according to claim 4, wherein the markings represent information on how many cups of coffee can be brewed with a corresponding filling level for coffee grounds.

6. The filter insert according to claim 1, wherein the strip includes an aromatic substance.

7. The filter insert according to claim 6, further including a coating on the strip to protect the aromatic substance, the coating being dissolvable when coming in contact with a fluid.

8. The filter insert according to claim 1, wherein the strip has a different color than the filter body.

9. The filter insert according to claim 1, wherein the filter insert comprises a filter paper.

10. A method for producing a cone-shaped filter insert, comprising:
conveying a filter material web;
placing at least one strip onto the filter material web being conveyed;
folding the filter material web so that the at least one strip is arranged inside the folded filter material web; and
cutting and embossing the folded filter material web for producing a filter insert.

11. The method according to claim 10, further including:
attaching the at least one strip to an embossed seam of the filter insert during the embossing of the filter material web.

12. The method according to claim 10, wherein the folding step creates a folded edge, and the placing step includes supplying the at least one strip so that the at least one strip extends parallel to the folded edge.
